(19) United States
(12) Patent Application Publication
(10) Pub. No.: US 2020/0208270 A1
(43) Pub. Date: Jul. 2, 2020

(54) LASER SURFACE STRUCTURING TREATMENT FOR PLATING

(71) Applicant: Continental Automotive Systems Inc., Auburn Hills, MI (US)

(72) Inventors: Jose Servin, Cuautla (MX); Felix Olivos, Cuautla (MX); Tabata Nothel, Cuernavaca (MX); Ruben Basurto, Jojutla (MX)

(21) Appl. No.: 16/683,976

(22) Filed: Nov. 14, 2019

Related U.S. Application Data
(60) Provisional application No. 62/785,402, filed on Dec. 27, 2018.

(51) Int. Cl. C23C 18/18; C23C 18/32; B23K 26/352; C23C 18/38; B23K 26/40; B08B 7/00

(52) U.S. Cl. CPC C23C 18/182; C23C 18/32; B08B 7/0042; C23C 18/38; B23K 26/40; B23K 26/352

(57) ABSTRACT

A method of plating a component includes specifying a sample type, specifying an area to be cleaned, programming a laser based on the sample type and specifications of the area to be cleaned, applying laser ablation on a surface of the area to be cleaned, performing surface activation if required, and performing electroless deposition.

### CROSS-REFERENCE TO RELATED APPLICATIONS

This application claims priority to U.S. Provisional Application No. 62/785,402, which was filed on Dec. 27, 2018 and is incorporated herein by reference.

### BACKGROUND

Electroless nickel plating can provide improved solderability to non-solderable materials. In particular, electroless nickel plating improves the solderability of materials, such as aluminum, through the deposition of a small layer of nickel-phosphorus on the surface of the area to be soldered. However, electroless nickel plating can be an expensive and process intensive approach to improve the solderability of non-solderable material surfaces.

### SUMMARY

In one exemplary embodiment, a method of plating a component includes specifying a sample type, specifying an area to be cleaned, programming a laser based on the sample type and specifications of the area to be cleaned, applying laser ablation on a surface of the area to be cleaned, performing surface activation if required, and performing electroless deposition.

In a further embodiment of any of the above, the electroless deposition provides a component with an aluminum-nickel coating.

In a further embodiment of any of the above, specifying a sample type includes specifying a type of material.

In a further embodiment of any of the above, the type of material includes one of aluminum, copper, stainless steel, or low alloy steels.

In a further embodiment of any of the above, the sample type includes an aluminum heat sink.

In a further embodiment of any of the above, specifying the area to be cleaned includes determining the area as a total area to be plated based on a geometry of a surface to be cleaned.

In a further embodiment of any of the above, programming the laser includes configuring equipment to specifications of the laser required for the material.

In a further embodiment of any of the above, programming the laser includes selecting a frequency of the laser based on the sample type.

In a further embodiment of any of the above, programming the laser includes selecting a speed of the laser based on the sample type.

In a further embodiment of any of the above, programming the laser includes selecting a current of the laser based on the sample type.

In a further embodiment of any of the above, programming the laser includes comparing mechanical geometric limitations of the laser with a geometry of the surface.

In a further embodiment of any of the above, the laser is a diode laser.

In a further embodiment of any of the above, if the material requires surface activation, activating the surface in order to make the surface catalytic for nickel adhesion.

In a further embodiment of any of the above, activating the surface includes placing the area into a zincate based solution.

In a further embodiment of any of the above, the electroless deposition applies a nickel plating to the area to be cleaned.

In a further embodiment of any of the above, a component is soldered to the nickel plating.

In a further embodiment of any of the above, the nickel plating includes a thickness of between 5.4 μm and 5.8 μm.

In a further embodiment of any of the above, the laser ablation on the surface extends at least one micron into the surface.

In a further embodiment of any of the above, the electroless deposition occurs on the area to be cleaned.

In a further embodiment of any of the above, prior to applying laser ablation, performing a cleaning pre-treatment on the area to be cleaned.

### BRIEF DESCRIPTION OF THE DRAWINGS

The disclosure can be further understood by reference to the following detailed description when considered in connection with the accompanying drawings wherein:

FIG. 1 shows a laser pre-treatment flowchart.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

The present disclosure seeks to address the problems related directly with solderability issues in SMT processes, specifically on EBS (Electronic Brake System) modules, replacing the material with a cheaper material (e.g. the high cost of tin plating on copper is replaced with aluminum-nickel coating), which can be easily produced in plant due to the operational facilities offered by the subject disclosure.

Currently, an electroless nickel-plated aluminum heat sink is used and the production cost of this part inhouse would be approximately 30% higher than that which is sold by a supplier. However, almost 40% of this price is given by the treatment of waste water associated with raw material, e.g. aluminum, pre-treatment. With the use of the laser in the production of such heat sinks, the projected cost would be approximately 20% less, which is a substantial savings, and there is a better solderability performance than currently offered by the supplier. Further, the disclosure addresses the general problems related with electronic industry like:

The high cost of tin plating on copper by replacing it with aluminum-nickel coating.

The expensive technology used currently in electroless process, with the use of laser technology it saves in infrastructure and other costs and it might be carried out in electronic industries without too much investment and less production costs.

The problems related with chemical pretreatments on the metal surfaces plating process such as:

The use of hazardous chemicals like HNO₃, HF, HCl, Alkali detergents, ZnO, etc.

The environmental risk due to the emissions of hazardous residues.

The dangerous residues treatment like the HF and HNO₃ neutralization or the alkali detergents treatment.

The high costs of metal plating process due to the costs of water, chemicals and the infrastructure.

Reduce the number of steps for clean pretreatment process.

Laser pretreatment includes applying a laser, more preferably a diode laser, on a metal substrate to clean it and engrave it at least one micron deep to remove grease, oxides, and any contamination on its surface. This eliminates all cleaning chemicals previously used for this purpose.

The applied area will be the same as the area to be coated with electroless nickel. The parameters of the laser are different depending on the type of material.

After laser application, it is possible to deposit a metallic layer via electroless on the treated substrate without any further cleaning pre-treatment and if desirable might do a pre-cleaning step with some detergent solution prior to laser treatment in order to remove the excess contaminants.

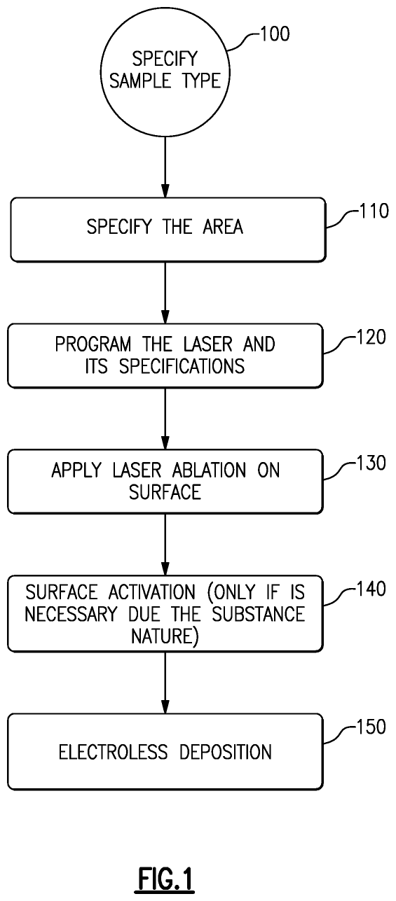

FIG. 1 shows the process flowchart for this disclosure. The process is simple and includes short steps to cleanliness. The substrate can be aluminum, copper, or stainless steel.

First, step 100 includes specifying the sample type. Is important to specify the sample to use in order to adjust the laser parameters due each type of material (e.g. copper, aluminum or steel). Each material has its own mechanical properties and requires more or less energy for ablation, and clean steel with aluminum parameters might burn the surface and lead to deficient treatment.

Next, step 110 includes specifying the area. In this step, the area to be cleaned is specified in order to program it in the laser equipment. The area is determined by the total area to be plated and depends from laser equipment capability. It should be mentioned that the geometry of the surface plays an important role in this step due to the nature of commercial laser equipment.

Next, step 120 includes programming the laser and its specifications. In this step, the equipment must be configured to the specifications of the laser required for the material. Below in Tables 1-4 are examples of the best configurations of the laser for four materials:

TABLE 1
Example for Aluminum Al 1050 Configuration.
Aluminum Al 1050

| | | |
|---|---|---|
| Wavelength | 1064 | nm |
| Speed | 500 | mm/s |
| Frequency | 22 | KHz |
| Current | 30 | Amp |
| Fill Interval | 0.07 | mm |

TABLE 2
Example for Cooper Configuration.
Cooper

| | | |
|---|---|---|
| Wavelength | 1064 | nm |
| Speed | 200 | mm/s |
| Frequency | 19.5 | KHz |
| Current | 30 | Amp |
| Fill Interval | 0.07 | mm |

TABLE 3
Example for Stainless Steel Configuration
Stainless Steel

| | | |
|---|---|---|
| Wavelength | 1064 | nm |
| Speed | 200 | mm/s |
| Frequency | 22 | KHz |
| Current | 27 | Amp |
| Fill Interval | 0.07 | mm |

TABLE 4
Example for Nickel-Steel Alloy
Nickel-Steel Alloy

| | | |
|---|---|---|
| Wavelength | 1064 | nm |
| Speed | 750 | mm/s |
| Frequency | 22 | KHz |
| Current | 30 | Amp |
| Fill Interval | 0.7 | mm |

Next, step 130 includes applying laser ablation on the surface. The laser application must be uniform and according to the area to be plated, a quality inspection is recommended in order to ensure if cleaning process was performed with a droplet angle measurement.

Next, step 140 includes surface activation. If the material requires it, activate the surface in order to make it catalytic for nickel adhesion. The surface activation can be performed by any known methods.

Next, step 150 includes electroless deposition. This can be carried out with any commercial or non-commercial solution and depends from the characteristics and properties desired. The process can be performed in alkali or acid bath, with or without additives, etc.

The use of this process provides the following advantages and benefits. There is a reduction of hazardous chemicals, processing time, and a reduction of process steps compared to prior processes. The versatility of the process is applicable on different kinds of substrates such as Aluminum, Steel, and Copper. The solderability of the nickel layer is very good compared with the substrates cleaned with chemicals. There is a reduction of the technology required, which makes it easier to produce nickel-plated parts and accordingly to improve product quality. Electroless tin parts can be replaced by less expensive electroless nickel aluminum parts. Further, the process is friendly with the environment and it does not create polluting emissions.

Surface Mount Technology (SMT) is a method for producing electronic circuits in which the components are mounted or placed directly onto the surface of PCBs. An electronic device that is made from this process is called a Surface Mount Device (SMD). The disclosure may be used in all SMD processes requiring solderable nickel surfaces, not only in the automotive industry because the disclosure does not interfere with the solderable properties of material and it may improve solderability of PCBs and reduce common defects (like voids, bad solderability) at a lower cost. The disclosure also can be applied in the materials investigation field especially in electroless nickel deposition research, and in addition it is possible to be applied in auto parts requiring nickel electrolytic coating (as mentioned above).

This disclosure also has application in the metallurgical, decoration, aeronautics, and construction industries. The disclosure also might be used in the field of metallurgy because of the use on metals and alloys.

Some example embodiments are discussed below.

### Example 1

An aluminum alloy (Al 1050) heat sink is subjected to various combinations of two pretreatments that are shown in Table 5.

TABLE 5
Experimental procedure in order to see the difference
between the chemical and laser pre-treatment.

| Sample | Type of cleaning | Surface |
|---|---|---|
| classification | pre-treatment | activation type |
| A | Laser | None |
| B | Laser | 1 Zincate |
| C | Laser | 2 Zincate |
| D | Chemical | 1 Zincate |
| E | Chemical | 2 Zincate |
| F | None | None |

In Tables 6 and 7 it is shown the laser treatment characteristics and the chemical pretreatment process which was used in this example. The chemical pre-treatment was based on conventional methods.

TABLE 6
Laser clean configuration
Laser

| Wavelength | 1064 | |
|---|---|---|
| Speed | 200 | mm/s |
| Frequency | 5000 | Hz |
| Current | 24 | Amp |

TABLE 7
Chemical clean pre-treatment
Chemical pretreatment

| Step | Solutions | Time | |
|---|---|---|---|
| 1 | NaOH 5% wt. | 30 | s |
| | Immersion | | |
| 2 | Rinse DI water | 1 | min |
| 3 | HNO₃ 50% wt. | 30 | s |
| | Immersion | | |
| 4 | Rinse DI Water | 1 | min |

Below is shown the composition of the activation bath (Table 8) that is based on a known method. Table 9 shows an example of a known non-commercial electroless nickel bath.

TABLE 8
Zincate surface activation bath composition
Zincate bath composition

| | | |
|---|---|---|
| ZnO | 100 | g/L |
| NaOH | 250 | g/L |
| Rochelle's salt | 10 | g/L |
| FeCl₂ | 1 | g/L |

TABLE 9
Composition of ENPP bath
Electroless Nickel-Phosphorous composition

| | |
|---|---|
| NiSO₄ | 0.1M |
| NaPO₂H2•H₂O | 0.2M |
| CH₃COOH | 2M (buffer pH 4.5) |
| CH₃COONa•3H₂O | |

After the cleaning, the samples were plated with an electroless phosphorous-nickel by immersion for a half hour at 90° C. in a bath with the identified composition. After the nickel deposition, the samples were pressed to a PCB and soldered to a BGA component. The thickness of nickel coat was measured by X-Ray fluorescence (XRF). The voids in BGA component were observed by X-Ray Computed Tomography (XRCT). The appearance of the nickel layer was evaluated by optical inspection.

The results are reported in Table 10.

TABLE 10
Results of aluminum metallization using laser to cleaning the surface of substrate.

| Results | | | | | | |
|---|---|---|---|---|---|---|
| Parameter | A | B | C | D | E | F |
| Thickness | 5.8 μm | 5.4 μm | 5.7 μm | 5.0 μm | 4.7 μm | 0.0 μm |
| Appearance | Good | Good | Very good | Good | Very good | Bad |
| Voiding | Acceptable | Acceptable | Acceptable | Acceptable | Acceptable | Unacceptable |
| Pressuring | Acceptable | Acceptable | Acceptable | Acceptable | Acceptable | Unacceptable |

The results show laser pretreatment is effective to clean the substrate before the electroless deposition with excellent results and it can be compared with the chemical cleanliness with the same results but less process steps, time, chemical substances and higher deposition rate.

### Example 2

An aluminum heat sink is subjected to a laser whose specifications are shown below in Table 11:

TABLE 11
Laser specifications for electroless nickel plating

| Wavelength | 1064 | |
|---|---|---|
| Speed | 500 | mm/s |
| Frequency | 22 | KHz |
| Current | 30 | Amp |
| Fill interval | 0.07 | mm |

After the laser pre-treatment samples were aged during 3, 7, 10 and 14 days at room temperature in storage conditions (without vacuum) prior to electroless nickel plating in order to determine the time in which the surface is cleaned under storage conditions prior to nickel plating (bath composition shown in Table 12).

TABLE 12
Composition of ENPP bath
Electroless Nickel-Phosphorous
composition

| | |
|---|---|
| NiSO₄ | 0.1M |
| NaPO₂H₂•H₂O | 0.2M |
| CH₃COOH | 2M (buffer pH 4.5) |
| CH₃COONa•3H₂O | |

The time in which the surface treated with the laser is cleaned under storage conditions was determined by plating the heat sinks in electroless nickel bath which composition is shown below:

After the nickel deposition, the samples were pressed to a PCB and soldered to a PCU/MCU component. The thickness of nickel coat was measured by X-Ray fluorescence (XRF). The voids in PCU component were observed by X-Ray Computed Tomography (XRCT). Appearance of the nickel layer was evaluated by optical inspection.

It was determined that the maximum period of time in which the samples were kept clean was one week. After this time the adhesion of the nickel layer and the solderability is affected.

All metals might require cleaning process prior electroless nickel deposition and more specifically: Aluminum and its alloys; Carbon and low-alloy steels; Steel nickel base alloys; and Copper and its alloys. These materials all need a surface activation prior to electroless nickel plating.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present disclosure.

Although the different examples have specific components shown in the illustrations, embodiments of this disclosure are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of plating a component comprising:
specifying a sample type;
specifying an area to be cleaned;
programming a laser based on the sample type and specifications of the area to be cleaned;
applying laser ablation on a surface of the area to be cleaned;
performing surface activation if required; and
performing electroless deposition.

2. The method according to claim 1, wherein the electroless deposition provides a component with an aluminum-nickel coating.

3. The method according to claim 1, wherein specifying a sample type includes specifying a type of material.

4. The method according to claim 3, wherein the type of material includes one of aluminum, copper, stainless steel, or low alloy steels.

5. The method according to claim 3, wherein the sample type includes an aluminum heat sink.

6. The method according to claim 3, wherein specifying an area to be cleaned includes determining the area to be cleaned as a total area to be plated based on a geometry of the surface to be cleaned.

7. The method according to claim 3, wherein programming the laser includes configuring equipment to specifications of the laser required for the type of material.

8. The method according to claim 7, wherein programming the laser includes selecting a frequency of the laser based on the sample type.

9. The method according to claim 7, wherein programming the laser includes selecting a speed of the laser based on the sample type.

10. The method according to claim 7, wherein programming the laser includes selecting a current of the laser based on the sample type.

11. The method according to claim 7, wherein programming the laser includes comparing mechanical geometric limitations of the laser with a geometry of the surface of the area to be cleaned.

12. The method according to claim 7, wherein the laser is a diode laser.

13. The method according to claim 3, wherein if the material requires surface activation, activating the surface in order to make the surface catalytic for nickel adhesion.

14. The method according to claim 13, wherein activating the surface of the area to be cleaned includes placing the surface into a zincate based solution.

15. The method according to claim 1, wherein the electroless deposition applies a nickel plating to the surface of the area to be cleaned.

16. The method of claim 15, further comprising soldering a component to the nickel plating.

17. The method according to claim 15, wherein the nickel plating includes a thickness of between 5.4 μm and 5.8 μm.

18. The method according to claim 1, wherein the laser ablation on the surface of the area to be cleaned extends at least one micron into the surface.

19. The method according to claim 1, wherein the electroless deposition occurs on the surface of the area to be cleaned.

20. The method according to claim 1, wherein prior to applying laser ablation, performing a cleaning pre-treatment on the surface of the area to be cleaned.
